(19) United States
(12) Patent Application Publication
(10) Pub. No.: US 2024/0313881 A1
(43) Pub. Date: Sep. 19, 2024

(54) NOISE MODELING FOR IMPROVED PROFILE MANAGEMENT

(71) Applicant: Comcast Cable Communications, LLC, Philadelphia, PA (US)

(72) Inventor: Jonathan Alan LEECH, Denver, CO (US)

(21) Appl. No.: 18/185,716

(22) Filed: Mar. 17, 2023

(51) Int. Cl. H04L 1/00

(52) U.S. Cl. CPC H04L 1/0003; H04L 1/0017

(57) ABSTRACT

Methods and systems are described for network communication. A network device may proactively assess the conditions of a network and generate or update a noise model. The noise model may be used to predict performance for a plurality of different modulation profiles. The network device may switch to the profile with the best predicted performance.

### BACKGROUND

Modulation profiles may be used to set parameters for communication between a server and one or more clients. In some cases, a modulation profile may be used that is sub-optimal. This may result in the slower transmission of information than is possible. Thus, there is a need for more sophisticated techniques for profile management.

### SUMMARY

Disclosed herein are methods and systems for network communication. A network device may communicate with one or more client devices via a network that is susceptible to noise and other variations. A variety of different modulation profiles are available to use to set the parameters of the communication via the network, and the network device may proactively assess the conditions of the network and switch between modulation profiles as needed. The modulation profiles may be applied to specific channels, such as a frequency channel or other logical or physical channel. As noise changes over time, the network device (or other computing device) may monitor the noise and generate or update a noise model to make predictions about which modulation profile may have the best performance for one or more of the channels. The noise model may comprise one or more distributions, such as histograms. Examples of distributions include a noise amplitude distribution, a noise interval distribution, and a noise duration distribution. Non-noise contributions may also be taken into account by the model for more accurate predictions. The noise model and non-noise contributions may be used to generate noise prediction metrics for different modulation profiles. The noise prediction metrics may comprise predicted modulation error ratio, percent failed, percent corrected, and/or the like. The noise prediction metrics may be used to determine the optimal modulation profile for a channel.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 shows an example system.

FIG. 2A shows an example method.

FIG. 2B shows example noise data.

FIG. 2C shows example noise data.

FIG. 2D shows example noise data.

FIG. 2E shows example noise data.

FIG. 2F shows example noise data.

FIG. 2G shows example noise data.

FIG. 3 shows an example method.

FIG. 4 shows an example method.

FIG. 5 shows an example method.

FIG. 6 shows an example computing device.

### DETAILED DESCRIPTION OF ILLUSTRATIVE EMBODIMENTS

Current techniques in use by Profile Management Applications (PMA) primarily rely on Modulation Error Ratio (MER) history and rough guidelines to do so. MER alone is an insufficient predictor of performance for alternative profiles. This is due to the averaging inherent in the MER calculation. Due to this limitation, conventional PMA assigns non-optimal profiles resulting in modulation errors, lower throughput, and unnecessary churn (e.g., toggling between profiles). These problems are directly affecting customers, as modulation errors equate to packet loss, and lower throughput reduces the available capacity of the network. The disclosed techniques overcome these problems with non-conventional approaches to predicting the performance of different modulation profiles. Instead of conventional, basic rules for switching modulation profiles, the present techniques utilize a noise prediction model that can predict which modulation profile will be optimal for a given time frame.

Disclosed herein are methods and systems for network communication. A network device, such as a termination system (e.g., cable modem termination system) may provide network access to a plurality of client devices. A physical communication link, such as a wired link or wireless link, may be used to facilitate the network and comprise a plurality of channels. The network device, or other computing device, may sample noise from the physical communication link. The sampled noise may comprise upstream noise, such as noise detected by the network device and associated with one or more of the plurality of client devices. The upstream noise may be introduced by one or more physical layer components (e.g., switch, network link, network node, etc.) between one or more of the plurality of client devices and the network device. Upstream noise may be detected by the network device or some other device in between the plurality of client devices and the network device. The network device, or other computing device, may use the noise to generate a noise model.

The noise model may comprise one or more distributions, such as histograms. Examples of distributions include a noise amplitude distribution, a noise interval distribution, and a noise duration distribution. The noise data may be analyzed on a chunk by chunk basis by taking a small number (e.g., ten) of sample bins. Noise amplitude and magnitude may be calculated for each chunk by analyzing each bin, or analyzing a portion of the bins, such as the center bin. The amplitude and/or magnitude may be analyzed and the one or more distributions may be updated (e.g., by incrementing a distribution bin matching the results of the analysis) to reflect the current data chunk in the noise model.

Non-noise contributions may also be taken into account by the model by a secondary calibration process. Noise is often the largest contributor to error rate metrics but not the only contributor. Non-noise contributions may be caused by a variety of issues, such as per modem receive power vs input level, ingress cancellation in CMTS, insufficient adaptive equalization-aka distortion, and optical path impairments. The variability may be due to a variety of issues, such as noise sampling error, utilization (e.g., variation over time, per modem, long/short codeword allocation, concatenation/interleaving), wind or vibration and plant impairments, temperature changes, water, and phase offset from noise and multiple non-noise sources. The non-noise component may be variable over time as well as per modem. Thus, the secondary calibration may account for non-noise components that are variable over time. The secondary calibration process may use the actual measured error values to solve for a system of equations. The equations may include a plurality of noise values (e.g., modulation error rate, forward error corrections) predicted by the model that are within threshold boundaries based on the actual noise values.

The noise model and non-noise contributions from the secondary calibration may be used to generate noise prediction metrics for different modulation profiles. The noise prediction metrics may comprise predicted modulation error ratio, percent failed, percent corrected, and/or the like. The noise prediction metrics may be used to determine the optimal modulation profile for a channel. The optimal profile may have the highest throughput with an acceptable error rate (e.g., above a threshold).

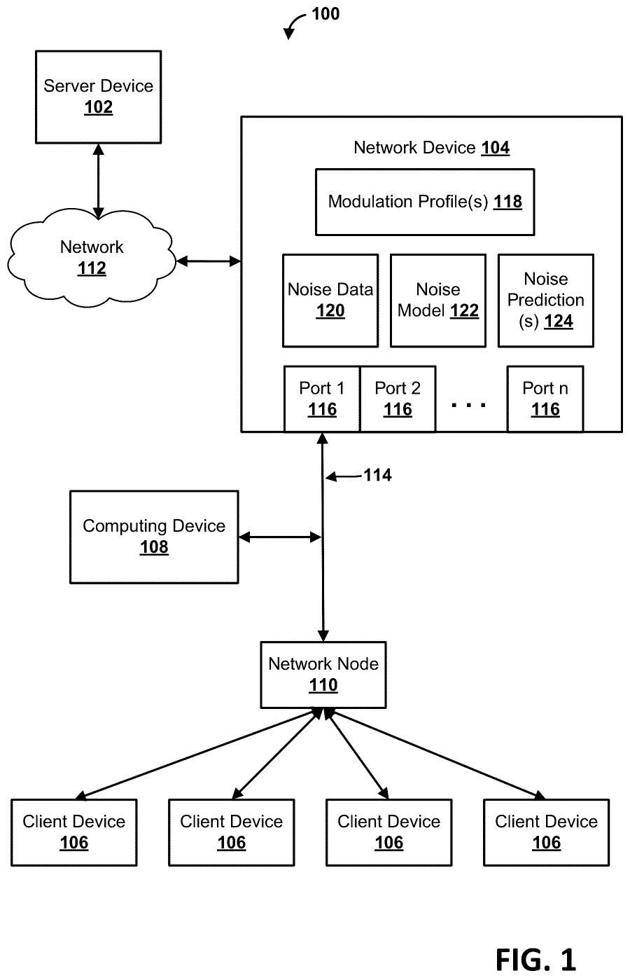

FIG. 1 shows a block diagram of an example system 100. The system 100 may comprise a server device 102, a network device 104 (e.g., a termination system, a cable modem termination system, a network node, or combination thereof), one or more client devices 106, a computing device 108, a network node 110, or a combination thereof. It should be noted that while the singular term device is used herein, it is contemplated that some devices may be implemented as a single device or a plurality of devices (e.g., via load balancing). The server device 102, the network device 104, the one or more client devices 106, the computing device 108, and/or the network node 110 may each be implemented as one or more computing devices. Any device disclosed herein may be implemented using one or more computing nodes, such as virtual machines, executed on a single device and/or multiple devices.

The server device 102, the network device 104, the one or more client devices 106, and/or the computing device 108 may be configured to communicate via one or more networks, such as a first network 112 and a second network 114. The first network 112 may comprise a content distribution and/or access network. The first network 112 may facilitate communication via one or more communication protocols. The first network 112 may comprise fiber, cable, a combination thereof. The first network 112 may comprise wired links, wireless links, a combination thereof, and/or the like. The first network 112 may comprise routers, switches, nodes, gateways, servers, modems, and/or the like.

The second network 114 may comprise fiber, cable, a combination thereof. The second network 114 may comprise wired links, wireless links, a combination thereof, and/or the like. The second network 114 may comprise routers, switches, nodes, gateways, servers, modems, and/or the like. The second network 114 may comprise network node 110. The network node 110 may be geographically located proximate to and provide service to the one or more client devices 106. Though not shown, it is contemplated that other network nodes may be geographically distributed to different locations to provide network service to a variety of clients at different locations. Each of the nodes, such as network node 110, may be communicatively coupled to a corresponding port of a plurality of ports 116 of the network device 104.

The second network 114 may comprise one or more networks in communication with the network device 104, the computing device 108, the network node 110, the one or more client devices 106 or a combination thereof. In some scenarios, the network device 104 and the computing device 108 may be implemented as a single device. In other scenarios, the computing device 108 may be a stand-alone device.

The network device 104 may comprise a computing device, a termination system, a cable modem termination system, an access point (e.g., wireless access point), a router, a modem, device controller (e.g., premises device controller), a combination thereof, and/or the like. The network device 104 may be configured to facilitate communication between the first network 112 and the second network 114. The one or more client devices 106 may comprise devices accessing the first network 112 via the network device 104. The network device 104 may be located at a service entity premises location. The one or more client devices 106 may be located at one or more corresponding customer premises location. The network device 104 may be configured to facilitate communication to allow for the one or more client devices 106 to access one or more services associated with the server device 102, such as a network service, a content service, a premises service, a communication service, a combination thereof.

The network device 104 may facilitate a network connection using a modulation technique such as quadrature amplitude modulation (QAM), Quadrature Phase Shift Keying (QPSK), or a combination thereof. The network device 104 may use full duplex operation (e.g., communication in both directions of the network at the same time), half duplex operation (e.g., communication in only one direction of the network at a time), or a combination thereof to communicate via the second network 114. The term upstream transmission as used herein refers to transmission from the one or more client devices 106 to the network device 104. The network node 110, computing device 108, and network device 104 may each be upstream from the one or more client devices 106. The computing device 108 and network device 104 may each be upstream from the network node 110. The network device 104 may be upstream from the computing device 108.

The network device 104 may be configured to store a plurality of modulation profiles 118. The network device 104 may use one or more of plurality of modulation profiles 118 to determine parameters for communicating via the second network 114. A modulation profile may comprise one or one parameters for encoding, modulating, transmitting data, or a combination thereof. The modulation profile may comprise one or more of a modulation order, a robustness value, a throughput value, a speed, a parity length, or a number of correctable bits.

A modulation profile may comprise a modulation mode (e.g., 64 QAM, 32 QAM, 16 QAM, 8 QAM, QPSK). Higher modulation orders have more speed (e.g., more bits per symbol) but less robustness (e.g., smaller targets). For each modulation, different modulation profiles may vary data and parity lengths to make different tradeoffs between throughput and robustness. A modulation profile may comprise an indication of short data+parity length (bits). A modulation profile may comprise an indication of long data+parity length (bits). A modulation profile may comprise an indication of correctable bits (t short/long). A modulation profile may comprise an indication of robustness (R), such an indication in a range between 1 (Lowest) and 5 (Highest). A modulation profile may comprise an indication of throughput (T), such an indication in a range between 1 (Lowest) and 5 (Highest). Table 1 shows example parameters for different modulation profiles.

TABLE 1

| | | | | | Short | Long | t |
|---|---|---|---|---|---|---|---|
| | | | | Speed | data + | data + | short/ |
| Profile | Modulation | Robustness | Throughput | (Mbps) | parity | parity | long |
| 251 | 64 QAM | 1 | 5 | 25.6 | 776 + | 1976 + | 16/ |
| | | | | | 32 | 64 | 32 |
| 261 | 64 QAM | 3 | 3 | 23.3 | 840 + | 1832 + | 80/ |
| | | | | | 160 | 208 | 104 |
| 266 | 64 QAM | 4 | 2 | 22.5 | 792 + | 1784 + | 104/ |
| | | | | | 208 | 256 | 128 |
| 271 | 64 QAM | 5 | 1 | 20.7 | 792 + | 968 + | 104/ |
| | | | | | 208 | 256 | 128 |
| 272 | 32 QAM | 5 | 1 | 17.8 | 768 + | 1104 + | 104/ |
| | | | | | 208 | 256 | 128 |
| 258 | 16 QAM | 2 | 4 | 16.5 | 808 + | 1912 + | 40/ |
| | | | | | 80 | 128 | 64 |
| 255 | QPSK | 1 | 5 | 8.7 | 744 + | 1976 + | 16/ |
| | | | | | 32 | 64 | 32 |
| 275 | QPSK | 5 | 1 | 6.7 | 712 + | 1088 + | 104/ |
| | | | | | 240 | 256 | 128 |

The network device 104 may assign a modulation profile to each of a plurality of communication channels (e.g., modulation channels, frequency domain channels). The communication channels may be channels within a frequency range and have an associated center frequency. Different communication channels may have different assigned modulation profiles. The modulation profile for each channel may be communicated to the one or more client devices 106, which may also use the assigned modulation profile for each channel. If the computing device 108 and/or the network device 104 determine to use a different modulation profile for one or more channels, an instruction may be sent via the second network 114 to the one or more client devices 106 indicating which modulation profile is now assigned to the channel.

The network device 104 and/or computing device 108 may be configured to perform any of the following operations associated with determining a modulation profile and/or updating an assignment of a modulation profile to a channel, device, port, and/or the like. For purposes of illustration, the network device 104 is described as performing the following operations, but it is understood that the computing device 108 may perform any of the operations of the network device 104.

The network device 104 may be configured to determine noise data 120 associated with communication between the network device 104 and the one or more client devices 106. The noise data may represent noise from a variety of sources. Common examples of noise may comprise environmental noise (e.g. thermal noise, electrical noise), noise caused by other devices (e.g., ingress noise), noise caused by network infrastructure (e.g., common path distortion noise), and/or the like. As an example, common path distortion (CPD) may comprise upstream noise (e.g., noise signals traveling towards a headend, network device, or other computing device from the direction of one or more client devices, and the noise signals may be combined via one or more branches connecting the client devices to a single common network branch) that may be created on a portion (e.g., coaxial portion) of a hybrid fiber cable systems. CPD may be generated when downstream signals mix in non-linear elements and create an upstream interference. As another example, ingress noise may comprise a radio signal from another device that leaks into a network. This and other noise may cause transmission problems, such as packet loss. To compensate, a modulation profile may be used that has a lower throughput but a higher error correction. Conventional systems may use basic rules to determine which modulation profile to use, resulting in situations in which a suboptimal modulation profile is used. The present techniques, however, disclose using the noise data to determine a new, non-conventional noise model that may provide more accurate prediction of network conditions. This approach may result in better selection of modulation profiles to improve throughput and minimize errors in network communication.

Determining the noise data 120 may comprise determining the noise data 120 based on one or more of capturing the noise data 120 or receiving the noise data 120 from an additional device, such as the network node 110, the computing device 108, or any of the one or more client devices 106. The noise data 120 may comprise measurements of upstream noise transmitted from the one or more client devices 106 to the network device 104. In some scenarios, the noise data 120 may comprise measurements of downstream noise transmitted from the network device 104 to the computing device 108, the network node 110, the one or more client devices 106, or a combination thereof. The noise data 120 may comprise only measurements of upstream noise (e.g., measured at the network device 104 or the computing device 108), only downstream noise data (e.g., measured at the network node 110, or the one or more client devices 106), or a combination of downstream and upstream noise. The upstream noise may be noise introduced at one or more client premises detectable upstream from the one or more client devices 106. Table 2 shows example noise data capture settings for a network device, such as a CMTS.

TABLE 2

| | Width | Resolution | Duration | | Quiet |
|---|---|---|---|---|---|
| Vendor | (MHz) | (kHz) | (μs) | Format | Time |
| Vendor 1 | 51.2 | 12.5 | 80 | Time IQ | yes |
| Vendor 1 | 102.4 | 25 | 40 | Time IQ | yes |
| Vendor 1 | 20.48 | 5 | 200 | Time IQ | yes |
| Vendor 2 | 50 | 100 | 10 | FFT | yes |
| | | | | Amplitude | |
| Vendor 2 | 80 | 100 | 10 | FFT | yes |
| | | | | Amplitude | |
| vCMTS | 102.4 | 25 | 40 | Time IQ | yes |
| WBFFT | | | | | |
| vCMTS | 204.8 | 50 | 20 | Time IQ | yes |
| WBFFT | | | | | |
| vCMTS | 51.2 | 12.5 | 80 | Time IQ | yes |
| WBFFT | | | | | |

The network device 104 (e.g., or computing device 108) may be configured to determine a noise model 122. The network device 104 may be configured to determine the noise model 122 based on the noise data 120. The noise model 122 may comprise one or more distributions of noise characteristics. The noise model 122 may comprise one or more of noise amplitude distribution data, noise duration distribution data, or noise interval distribution data. The noise amplitude distribution data may comprise noise amplitude histogram data indicating a distribution of noise amplitude values. The noise duration distribution data may comprise noise duration histogram data indicating a distribution of noise duration values. The noise interval distribution data may comprise noise interval histogram data indicating a distribution of intervals between noise values. The noise model 122 may be determined by subdividing the noise data 120 into data chunks and analyzing each of the data chunks, such as by determining amplitude, magnitude of amplitude, metrics based on the amplitude, and/or the like. Each chunk may comprise a plurality of sampled bins of data. Each bin may be analyzed or only a portion of the bins may be analyzed, such as a single bin (e.g., the center bin). The result of the analysis may be used to determine noise amplitude distribution data, noise duration distribution data, noise interval distribution data. Each of the noise amplitude distribution data, noise duration distribution data, noise interval distribution data (e.g., or histograms) may be updated by incrementing a value in the distribution that corresponds to the analyzed chunk. Each distribution may have a range of values with corresponding counts for each value according to the analysis of each of the data chunks.

At least one of the one or more distributions of noise characteristics may be modified over time based on a decay rate. The decay rate may bias the one or more distributions towards more recent noise data (e.g., by ignoring or giving older noise data less weight).

The network device 104 may be configured to determine a calibration associated with a non-noise contribution. The network device 104 may be configured to determine the calibration associated with a non-noise contribution based on the noise model 122. Determining the calibration may comprise solving for coefficients for a system of equations for one or more metrics, such as error metrics. Determining the calibration may comprise determining a plurality of predicted error values in a range limited based on error values determined using the noise data. The plurality of predicted error values may comprise one or more of a modulation error rate, a signal-to-noise ratio, or a forward error correction metric.

The network device 104 may be configured to determine one or more expected noise metrics 124 (e.g., or noise prediction value, predicted performance values) for a modulation profile (e.g., for each of the modulation profiles) of a plurality of modulation profiles 118. The one or more expected noise metric 124 may comprise one or more of a predicted amount of noise, a level of noise, modulation error rate, a signal-to-noise ratio, a forward error correction metric, a corrected percentage, a failed percentage. The one or more expected noise metrics may comprise a predicted modulation error rate, one or more predicted forward error correction (FEC) metrics, or a combination thereof. The one or more expected noise metrics (e.g., predicted forward error correction metrics) may comprise a corrected FEC (e.g., percentage corrected). The one or more expected noise metrics (e.g., predicted forward error correction metrics) may comprise an uncorrected FEC (e.g., percentage failed to correct).

The network device 104 may be configured to determine the one or more expected noise metrics 124 for a modulation profile of a plurality of modulation profiles 118 based on the noise model 122. Determining the one or more expected noise metrics 124 may be based on the calibration associated with a non-noise contribution.

The calibration may comprise determining one or more calibration boundaries. The one or more boundaries may be based on actual data associated with a modulation profile used for the network, such as an actual MER, an actual failed FEC (e.g., percentage failed), an actual corrected FEC (e.g., percentage corrected), and an actual unerrored FEC (e.g., percentage unerrorred, failed FEC minus corrected FEC). The one or more boundaries may comprise a lower boundary. The lower boundary may be determined based on raising a first calibration metric until the predicted FEC values are lower than the actual FEC values and the MER is higher than the actual MER values. The upper boundary may be determined by lowering a second calibration metric until predicted FEC values are higher and MER lower than actuals values (e.g., failedPct higher than actual, unerroredPct lower than actual, and the ratio of failed to corrected higher than actual).

The calibration may comprise determining a plurality of weights based on the one or more calibration boundaries. The plurality of weights be coefficients in a set of equations including a plurality of possible values for MER, uncorrected FEC, and corrected FEC. The set of equations may comprise a MER equation comprising a first side of an equation comprising a range of predicted values of MER and weights applied to the predicted values and a second side of the equation comprising actual MER. The range of predicted values may be determined based on using the model to predict MER values within the one or more boundaries. The set of equations may comprise an uncorrected FEC equation comprising a first side of an equation comprising a range of predicted values for uncorrected FEC and weights applied to the predicted values and a second side of the equation comprising actual uncorrected FEC. The range of predicted values of uncorrected FEC may be determined based on using the model to predict uncorrected FEC values within the one or more boundaries. The set of equations may comprise a corrected FEC equation comprising a first side of an equation comprising a range of predicted values of corrected FEC and weights applied to the predicted values and a second side of the equation comprising actual corrected FEC. The range of predicted values of corrected FEC may be determined based on using the model to predict corrected FEC values within the one or more boundaries. Each of the first side of the equations may be set equal to the corresponding second sides (e.g., the actual values). The set of equations may be solved to determine weights for each of the equations. If the equation is unsolvable, one or more constraints for the set of equations may be removed according to an order of priority until the equations are solvable.

The weights may be used to determine the one or more noise prediction values 124 for each of the plurality of modulation profiles 118. A range of predicted MER, corrected FEC, and/or uncorrected FEC may be determined (e.g., based on the one or more boundaries). The corresponding weights may be applied to each of the ranges of predicted MER, corrected FEC, and/or uncorrected FEC. As a result, a predicted MER, corrected FEC, and/or uncorrected FEC may be determined for each modulation profile (e.g., of a plurality of predefined profiles, of various generated profiles).

The network device 104 may be configured to determine to use the modulation profile for the network device. The network device 104 may be configured to determine to use the modulation profile for the network device based on the one or more expected noise metrics 124. Determining to use the modulation profile may comprise determining that the modulation profile satisfies one or more conditions associated with network performance. The one or more conditions may comprise one or more of a throughput condition (e.g., bandwidth, bit rate) or an error rate condition. The one or more conditions may comprise a combination of the highest throughput and the lowest error rate. The one or more conditions may comprise a combination of a throughput being above a threshold and an error rate being below a threshold. The network device 104 may be configured to send data indicative of the modulation profile. Sending data indicative of the modulation profile may comprise one or more of sending an identifier of the modulation profile, sending a command to use the modulation profile for a channel, or sending a message to the one or more client devices 106. If the computing device 108 determines the modulation profile, the data indicative of the modulation profile may be sent to the network device 104 to cause the network device 104 use the modulation profile.

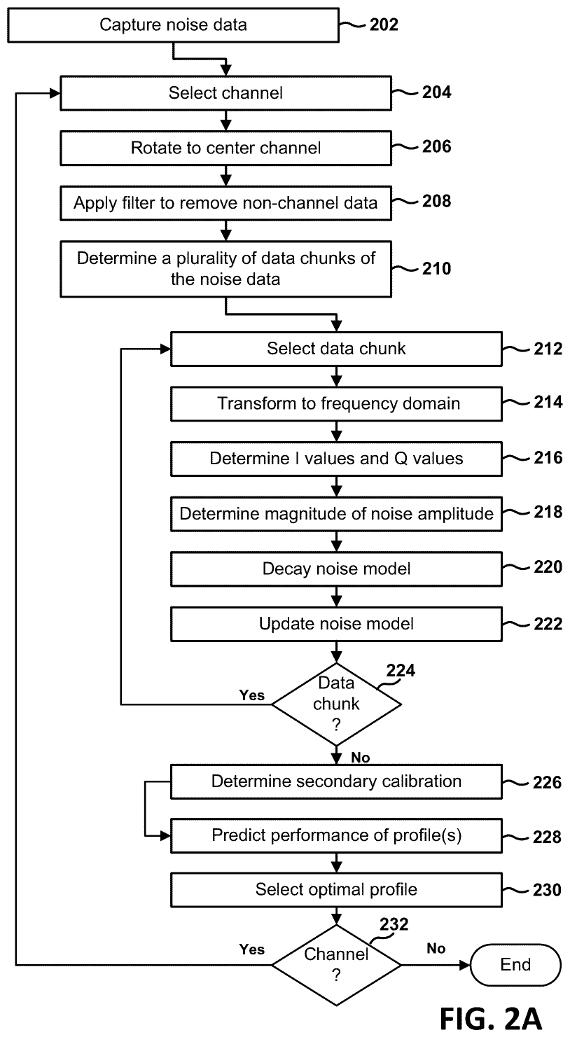

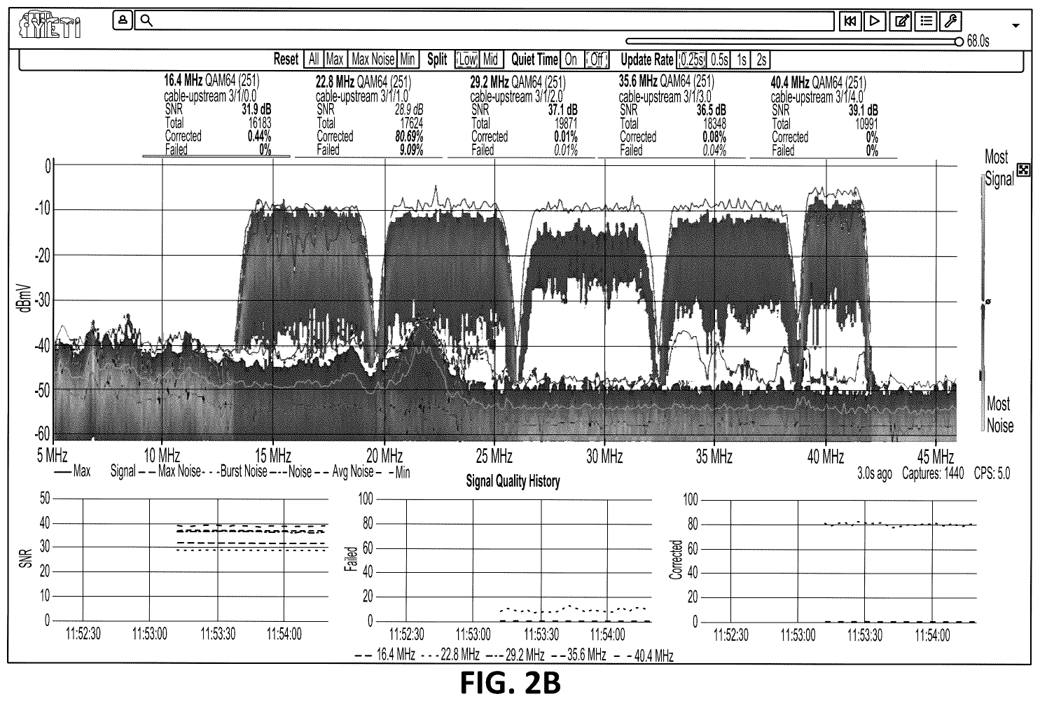

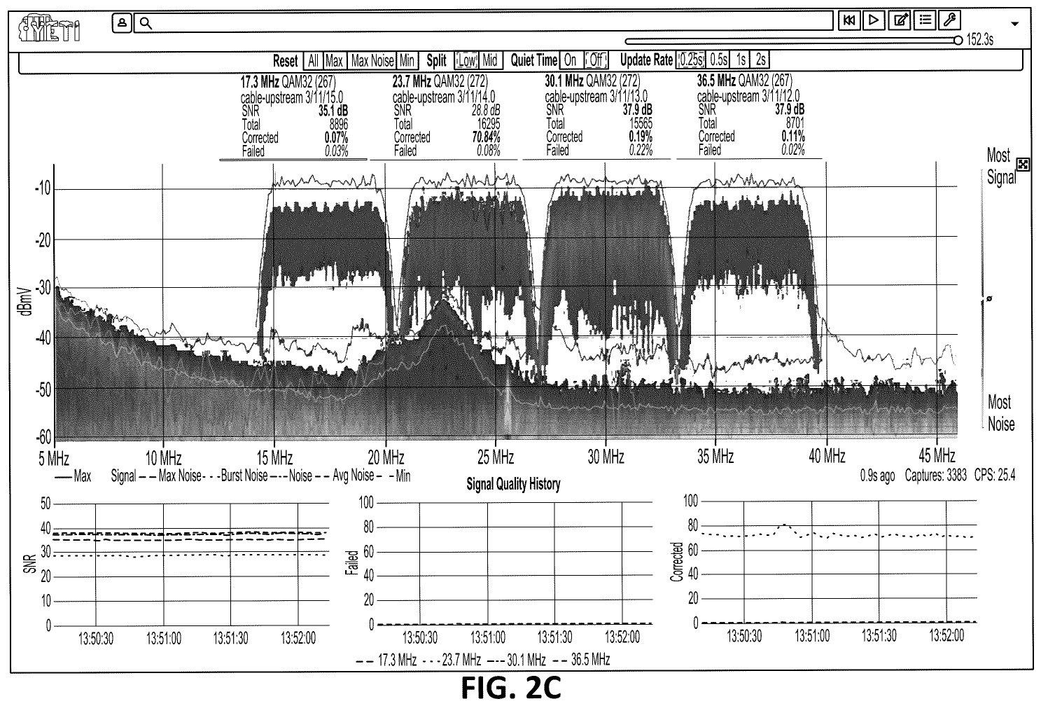

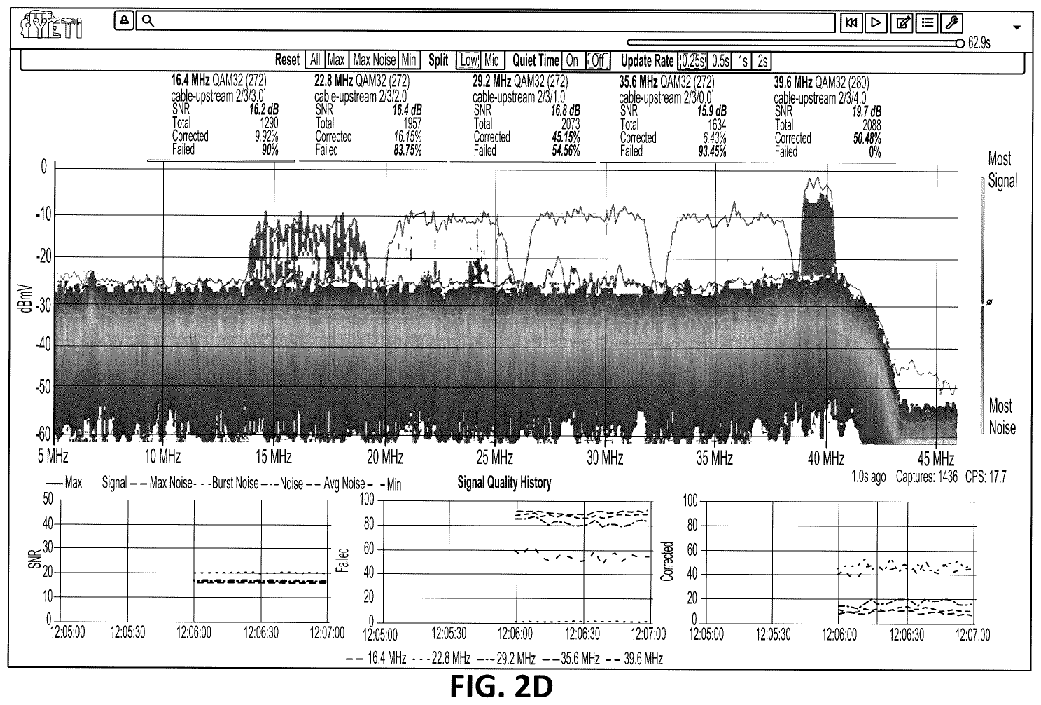

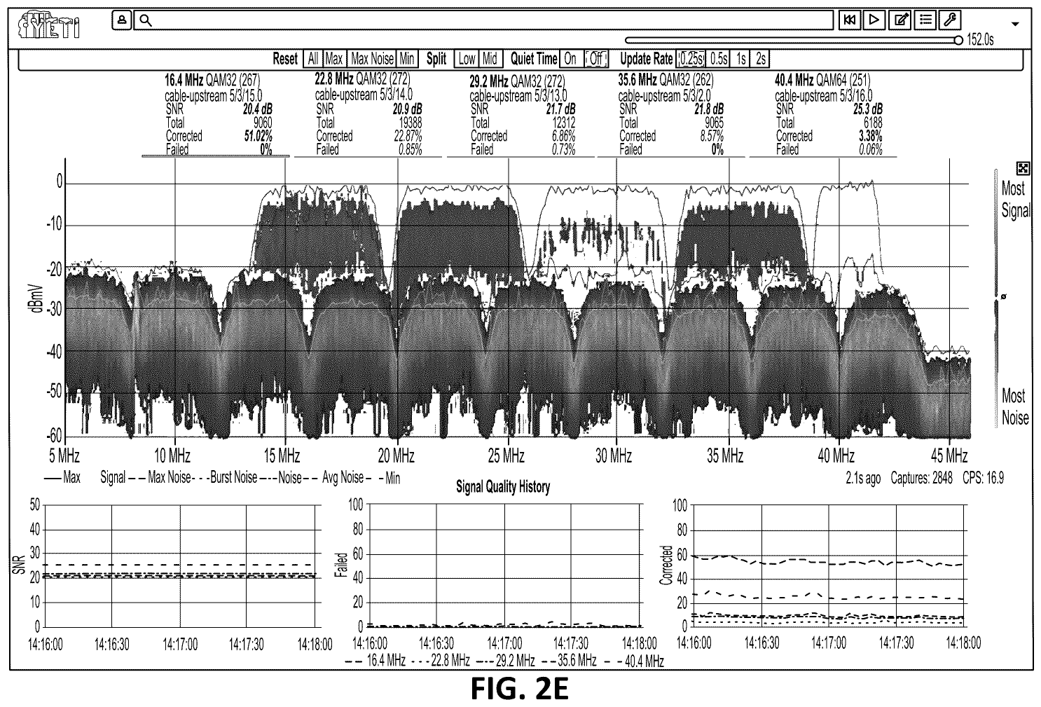

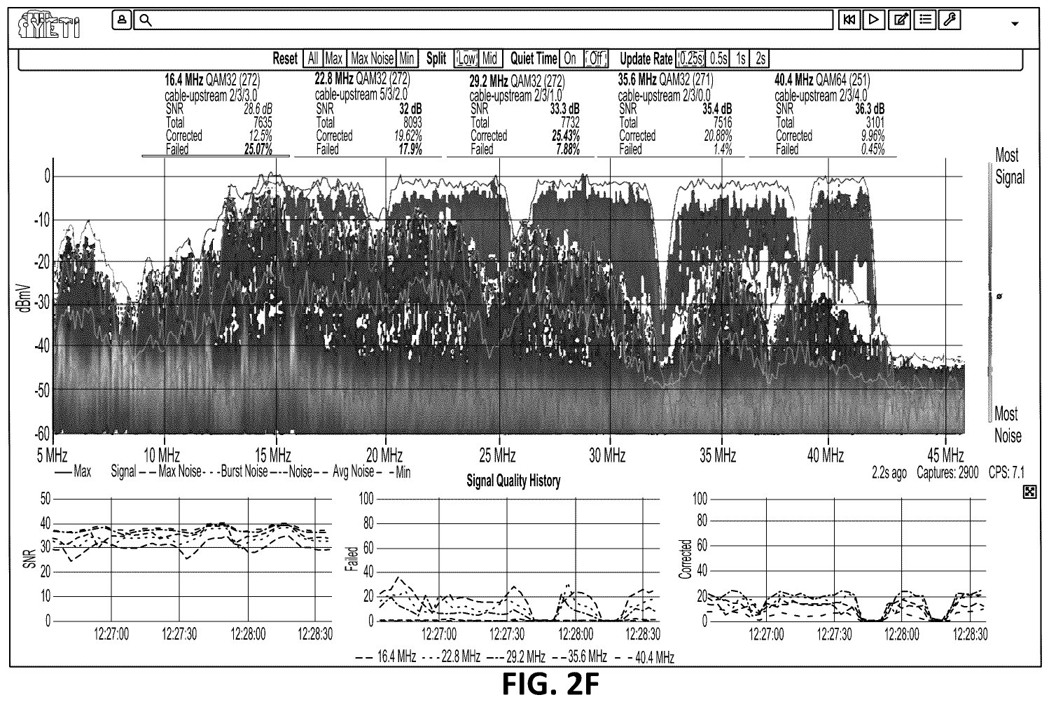

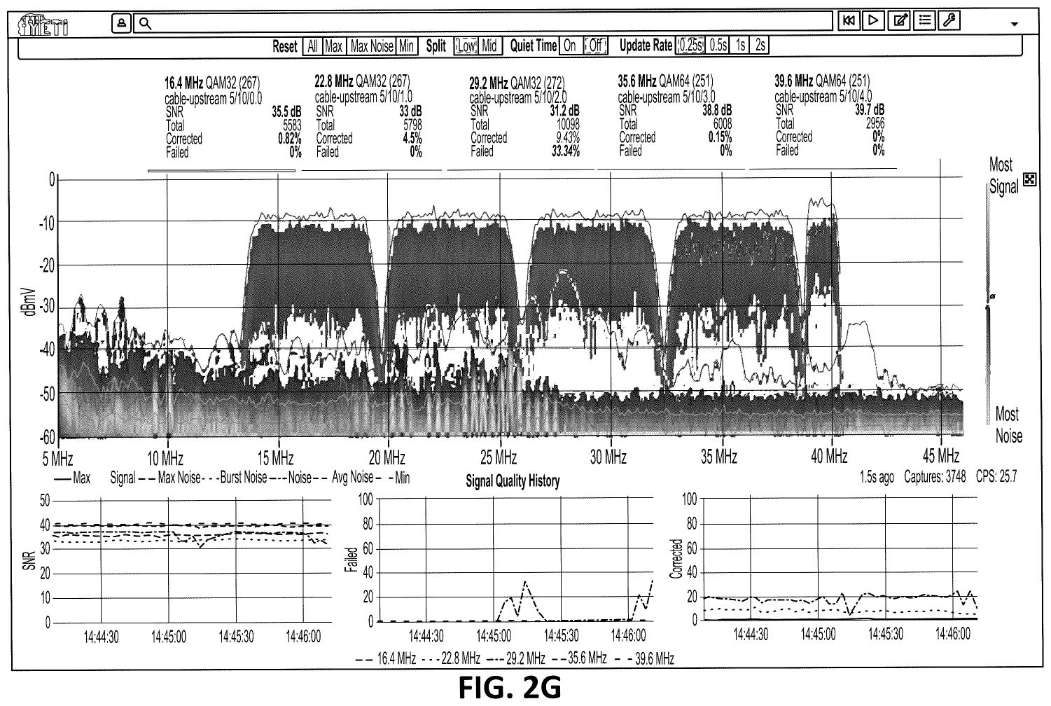

FIG. 2A shows an example method for selecting an optimal modulation profile. The network device 104, computing device 108, the network node 110, or the one or more client devices 106 may be configured to perform any of the steps, or any combination of steps described as part of the method 200 for selecting an optimal modulation profile.

As a general overview, the method may be applied to each of one or more channels in a data capture. For each channel, one or more of the following may be determined: the channel RxPower, the RxPower of each modem, the MER, and the FEC. Noise captures, channel MER, and channel FEC may be acquired. A noise model may be determined (e.g., generated using the captured noise). Predictions may be made, using the noise model, for different modulation profiles to apply to the channel. The optimal modulation profile for the channel may be determined. The optimal modulation profile may reduce FEC errors to an acceptable threshold (e.g., less than 1 percent). The optimal modulation profile may be set for the channel (e.g., and a PMA event may be created). The PMA event may be created by a PMA. The PMA may create the PMA event based on determining that one or more thresholds are satisfied. The one or more thresholds may be satisfied if the selected optimal modulation profile does not have enough throughput to achieve desired speeds for end users. The one or more thresholds may be satisfied if the selected optimal modulation profile is unable to sufficiently mitigate errors. The creation of the PMA event may indicate that further action is required by a maintenance team to fix the underlying issues in the network.

At step 202, noise data may be captured. The noise data may be captured by a network device, such as a cable modem termination system. The noise data may comprise noise data on a connection between one or more client devices (e.g., cable modems) and the network device. The noise may be captured from a network link upstream from the one or more client devices. Capturing the noise data may comprise sampling the spectrum to capture noise (e.g., and noise-like phenomena such as CPD) during the non-transmit times. The noise data may be captured using Quiet Time captures (e.g., while the link is not used for transmissions), a signal/noise classification algorithm (e.g., if captured during a transmission time), or a combination thereof. The modulation error ratio (MER) (e.g., channel average MER) may also be captured (e.g., as frequently as possible) while capturing the noise data. The modulation profile currently in use for each channel may also be used. Each sample of the noise data may be in Time IQ format and contains the spectrum for several SC QAM channels and/or OFDMA channels. The spectrum for each channel may contain noise, signal, or a combination of both across the capture time. The capture time may be relatively long; e.g. 80 microseconds for a 51.2 MHZ wide capture with 4096 bins.

At step 204, a channel of the noise data may be selected. The channel may be a QAM channel, OFDMA channel, full duplex (FDX) channel, and/or the like. The channel may be, for example, one of five channels, such as a channel centered at 16.4 Mhz, 22.8 MHZ, 29.2 MHz, 35.6 MHz, or 40.4 MHZ.

At step 206, a transform (e.g., rotation transform) may be applied to center the noise data at a center of the selected channel.

At step 208, a filter may be applied to remove portions of the noise data outside of the selected channel. For example, any data below a lower channel threshold may be removed and any data above a higher channel threshold may be removed. The lower channel threshold and the higher channel threshold may define the range of the channel.

At step 210, a plurality of data chunks may be determined from the noise data remaining from step 208 (e.g., the noise data for the selected channel with the non-channel data removed). The noise data from step 208 may be subdivided into the plurality of data chunks. The data chunks may be selected such that the noise may be analyzed (e.g., or “played back”) on a per symbol basis. For a 6.4 MHZ SQ QAM channel with 5.12 mega symbols/sec, 4096 bins may be captured in a sample, each data chunk may be 10 bins, and the FFT size may be 10.

At step 212, a data chunk of the plurality of data chunks from step 210 may be selected. The data chunk may comprise, for example, 10 bins of the noise data. The data chunk may be the next data chunk in a sequence of data chunks.

At step 214, a transform may be applied to the data chunk to convert the data chunk from a time domain to a frequency domain. The transform may comprise a Fourier transform, such as a fast Fourier transform. A hanning window may be applied to the selected data chunk before the transform to the frequency domain is applied.

At step 216, I and Q values may be determined from the data chunk converted to the frequency domain. The I and Q values may be from the center bin (e.g., the center bin of the 10 bins) of the data chunk (e.g., or other bin/combination/average of bins may be used).

At step 218, a magnitude of noise amplitude may be determined based on the I and Q values. The magnitude may be determined based on the following formula: 20*log 10(abs(b))−cal, where b represents the values of the center bin and cal is a calibration parameter. The signal-to-noise ratio (SNR) may be determined by adding abs(b)\hat{ }2 to the sum. The sum may comprise a running total or sum of the error. The sum may be used in the denominator of the SNR MER formula.

At step 220, a decay algorithm may be applied to a current noise model. In some implementations, applying the decay algorithm may be optional. The decay algorithm biases the noise model towards more recent noise data captures. Older data may be removed from the algorithm and/or given less weight.

At step 222, the noise model may be updated. The noise model may characterize noise amplitude, noise duration, noise interval, or any combination thereof. The noise model may comprise noise amplitude distribution data (e.g., a noise amplitude histogram). The noise amplitude distribution data may comprise a count of samples for each dB value. The noise amplitude distribution data may be used to estimate symbol error magnitude and modulation error ratio (MER).

The noise model may comprise noise duration distribution data (e.g., a noise duration histogram). The noise duration distribution data may indicate how often noise is at one or more specific dB level or higher for each duration. The noise duration data may comprise a count of instances of noise at each dB level (or higher) for each possible symbol duration (e.g., 1-409 symbols). For example, at a symbol duration of 195 ns, 80 us capture duration, a noise duration may be from 1 to 409 symbols.

The noise model may comprise noise interval distribution data (e.g., a noise interval histogram). The noise interval distribution data may indicate intervals between noise at one or more specific dB level or higher. The noise interval distribution data may comprise an interval between instances of noise at each dB level (or higher). If the interval is less than a codeword length and dB is greater than a threshold, a symbol modulation error may be guaranteed. The codewords may comprise a plurality of symbols. If there is 1 or more symbol error, then the codeword may be either corrected or uncorrected, as opposed to unerrored. A duration histogram may provide an estimate of the number of consecutive errored symbols in the codeword. If a total duration exceeds correction ability, the error may be the FEC error. Otherwise, the error may be a FEC corrected error. An interval histogram may provide the quantity of unerrored symbols that occur between the symbol errors. If the interval is greater than the codeword length, they may be a probability of a modulation error. The predictor may simulate codewords comprising unerrored and errored symbols based on the magnitude, duration, and interval histograms. The predictor may compute the MER and FEC rates.

At step 224, a determination may be made as to whether any data chunks of the plurality of data chunks have not been processed. If yes, the method may return to step 212 to process the next data chunk. If no, the method may proceed to step 226.

At step 226, a secondary calibration may be determined. The secondary calibration (e.g., +−dB in noise model) may account for non-noise contributions and/or variability. Non-noise contributions may be caused by a variety of issues, such as per modem receive power vs input level (+ or −), ingress canceler in CMTS (+), insufficient adaptive equalization-aka distortion (−), and optical path impairments (−). The variability may be due to a variety of issues, such as noise sampling error, utilization (e.g., variation over time, per modem, long/short codeword allocation, concatenation/interleaving), wind or vibration and plant impairments, temperature changes, water, and phase offset from noise and multiple non-noise sources.

The secondary calibration may comprise predicting forward error correction (FEC) and modulation error ratio (MER) for modulation profile, short and long codewords, interleaving depth, secondary calibration, the noise model, and/or the like.

Noise is often the largest contributor to EVM/MER, but not the only. Non-noise contributors include differences in receiver power per modem, ingress cancellation in the CMTS, insufficient or volatile adaptive equalization, and optical path impairments. The non-noise component may be variable over time as well as per modem. Thus, the secondary calibration may account for non-noise components that are variable over time.

Determining the secondary calibration may comprise computing the non-noise contribution (NN) by modeling the MER and FEC using the noise model and the current profile settings. NN may comprise a set of coefficients a, b, c, d . . . representing an amount of time for each, as well as a dB offset, and corresponding MER, FEC rates. A range of dB offsets may be determined, by applying the noise model to a modulation model and establish an upper and lower bound such that range is greater than and less than the actual MER, as well as the FEC error and corrected rates.

Determining the secondary calibration may comprise solving for secondary calibration coefficients (e.g., a, b, c, d, etc. . . . ) to determine a closest solution for actual values, such as actual FEC, actual MER, and/or the like. An example set of equations may be formulated and solved using any available technique, such as linear algebra. The following set of equations may be used to solve:

$$a + b + c + d + … = 1 \qquad ( 1 )$$

$$a * MER 1 + b * MER 2 + c * MER 3 + d * MER 4 + … = MER actual \qquad ( 2 )$$

$$a * ERR 1 + b * ERR 2 + c * ERR 3 + d * ERR 4 + … = ERR actual \qquad ( 3 )$$

$$a * COR 1 + b * COR 2 + c * COR 3 + d * COR 4 + … = COR actual \qquad ( 4 )$$

The coefficients of the secondary calibration (e.g., a, b, c, d, etc. . . . ) may be determined based on the actual MER, actual uncorrected FEC rate (ERR), and actual corrected FEC rate (COR) measured and/or calculated for a channel (e.g., during step 202) while the original modulation profile is being used. The coefficients of the secondary calibration may be determined based on a plurality of predicted values using the noise model. The plurality of predicted values may comprise a plurality MER values (e.g., MER1, MER2, MER3, MER4, etc.), a plurality of ERR values (e.g., ERR1, ERR2, ERR3, ERR4, etc.), a plurality of COR values (e.g., COR1, COR2, COR3, COR4, etc.), or any combination thereof. The plurality of predicted values may be determined by determining of range of predicted values (e.g., range of MER values, range of ERR values, range of COR values) based upper bounds and/or lower bounds. The range of values may be values determined using the noise model to generate values between the lower bound and the upper bound. The secondary calibration may comprise establishing lower and upper bounds of secondary calibration using actual FEC, MER, and modulation profile. The secondary calibration may comprise creating a range of FEC and MER estimates between bounds. After the coefficients are determined, the coefficients may be applied to other modulation profiles to predict FEC and MER. The noise model may be called on each profile over the same range of secondary calibration. The predicted FEC and MER may be computed as weighted averages.

At step 228, the performance of one or more modulation profiles may be predicted based on the noise model. In some scenarios, step 228 may be triggered based on detection of a condition (e.g., instead of or in additional to being triggered by completion of processing all the data channels). For each modulation profile, a plurality of code words may be simulated. The noise model and/or secondary calibration may be used to determine simulated MER, FEC, and/or other metrics based on the simulated codewords for the modulation profile.

MER may be calculated using the following equation:

$$10 \times log 10 [ \frac{{\sum }_{j = 1}^{N} ( {I}_{j}^{2} + {Q}_{j}^{2} )}{{\sum }_{j = 1}^{N} ( δ {I}_{j}^{2} + δ {Q}_{j}^{2} )} ] \qquad ( 5 )$$

The actual MER may be determined. The actual MER may comprise the overall channel MER determined by a network device, such as a CMTS. Signal-to-noise ratio may be determined. SNR may comprise an estimate of MER (ideal channel+real noise), computed in creating the noise model. The estimate of MER may comprise the total and count computed in creating the noise model.

The SNR may be estimated using the noise model by making a few modifications to the standard MER calculations. The summations in the MER calculation may be replaced with averages. The numerator may be determined by computing avg(I\hat{ }2+Q\hat{ }2), normalized to rxPower and cal; e.g. 10\hat{ }((cal+rxPower)/10). The denominator may be determined using avg noise I\hat{ }2+Q\hat{ }2 from steps 204-222. This may be used to estimate MER per profile incorporating estimated symbol and bit errors and secondary calibration.

At step 230, an optimal modulation profile may be selected the channel. The optimal modulation profile may be determined based on comparing the predicted performance of the one or more modulation profile. The optimal modulation profile may be the profile with the highest performance. The optimal modulation profile may be a modulation profile that has an acceptable uncorrected FEC, a highest throughput, or the best combination of uncorrected FEC and throughput.

At step 232, a determination may be made as to whether any channels of the noise data captured in step 202 have not been processed. If yes, the method may return to step 204 to process the next channel. If no, the method may end.

The technique above is applicable to any burst transmission so would apply to current SQ QAM and OFDMA upstream traffic. The technique may be applicable downstream using FDX. The technique could be applied in the context of cell phones. The noise model could be implemented in modem software on the error vector and applied to the downstream.

FIGS. 2B-G provide examples of captured noise data associated with a hybrid fiber cable network between a cable modem termination system and client devices and the associated results of applying the techniques disclosed herein to predict performance of a modulation profile. These examples are provided for purposes of illustration only and do not limit application of the present teachings to the examples shown.

FIG. 2B shows example noise data. The noise data shows an example noise hump. The noise data may have the following measured/calculated values: “centerFrequency”: 22.8 MHZ, “width”: 6.4, “inputLevel”: 0.0, “modProfile”: 251, “avgMer”: 28.9, “snr”: 33.4, “avgFailedPct”: 9.21, “avgCorrectedPct”: 79.99. A noise model was generated and provided the following predictions for modulation profile 251 and 261: “predictions”: {“_251”: [{“mer”: 26.7, “failedPct”: 9.21, “correctedPct”: 78.25} ], . . . “_261”: [{“mer”: 26.026926905779582, “failedPct”: 0.26, “correctedPct”: 87.28} ]. The recommendation is to downgrade to 64 QAM R3 T3.

FIG. 2C shows example noise data. The noise data shows another example noise hump. The noise data may have the following measured/calculated values: “centerFrequency”: 23.7 MHz, “width”: 6.4, “inputLevel”: 0.0, “modProfile”: 272, “avgMer”: 28.7, “snr”: 31.0, “avgFailedPct”: 0.15, “avgCorrectedPct”: 72.45. A noise model was generated and provided the following predictions for modulation profile 272 and 266: “predictions”: {“_272”: [{“mer”: 26.9, “failedPct”: 0.15, “correctedPct”: 72.45} ], . . . “_266”: [{“mer”: 26.7, “failedPct”: 0.39, “correctedPct”: 87.54,}]. The recommendation is to upgrade to 64 QAM R4 T2.

FIG. 2D shows example noise data. The noise data shows an example of common path distortion noise. The noise data may have the following measured/calculated values: “centerFrequency”: 35.6 MHZ, “width”: 6.4, “inputLevel”: 0.0, “modProfile”: 272, “avgMer”: 16.0, “snr”: 19.6, “avgFailedPct”: 91.29, “avgCorrectedPct”: 8.58. A noise model was generated and provided the following predictions for modulation profile 272 and 255: “predictions”: {“_272”: [{“mer”: 14.1, “failedPct”: 93.72, “correctedPct”: 6.15} ], . . . “_255”: [{“mer”: 11.3, “failedPct”: 0.68, “correctedPct”: 20.67} ]. The recommendation is to downgrade to QPSK R1 T5.

FIG. 2E shows example noise data. The noise data shows another example of common path distortion noise. The noise data may have the following measured/calculated values: “centerFrequency”: 35.6 MHZ, “width”: 6.4, “inputLevel”: 10.0, “modProfile”: 262, “avgMer”: 21.8, “snr”: 28.4, “avgFailedPct”: 0.01. “avgCorrectedPct”: 9.49. A noise model was generated and provided the following predictions for modulation profile 262 and 271: “predictions”: {“_262”: [{“mer”: 21.1, “failedPct”: 0.01, “correctedPct”: 9.49} ], . . . “_271”: [{“mer”: 21.0, “failedPct”: 0.22, “correctedPct”: 27.04} ]. The recommendation is to upgrade to 64 QAM R5 T1.

FIG. 2F shows example noise data. The noise data shows an example of ingress noise. The noise data may have the following measured/calculated values: “centerFrequency”: 16.4 MHZ, “width”: 6.4, “inputLevel”: 10.0, “modProfile”: 272, “avgMer”: 30.2, “snr”: 26.7. “avgFailedPct”: 10.8, “avgCorrectedPct”: 7.28. A noise model was generated and provided the following predictions for modulation profile 272 and 275: “predictions”: {“_272”: [{“mer”: 27.7, “failedPct”: 10.8, “correctedPct”: 7.28,} ], . . . “_275”: [{“mer”: 26.6, “failedPct”: 4.29, “correctedPct”: 0.15} ]. The recommendation is to downgrade to QPSK R5 T1.

FIG. 2G shows example noise data. The noise data shows another example of ingress noise. The noise data may have the following measured/calculated values: “centerFrequency”: 16.4 MHZ, “width”: 6.4, “inputLevel”: 0.0, “modProfile”: 267, “avgMer”: 35.3, “snr”: 39.3, “avgFailedPct”: 0.0, “avgCorrectedPct”: 0.8. A noise model was generated and provided the following predictions for modulation profile 267 and 251: “predictions”: {“267”: [{“mer”: 35.5, “failedPct”: 0.0, “correctedPct”: 0.8} ], . . . “_251”: [{“mer”: 35.5, “failedPct”: 0.18, “correctedPct”: 1.7} ]. The recommendation is to upgrade to 64 QAM R1 T5.

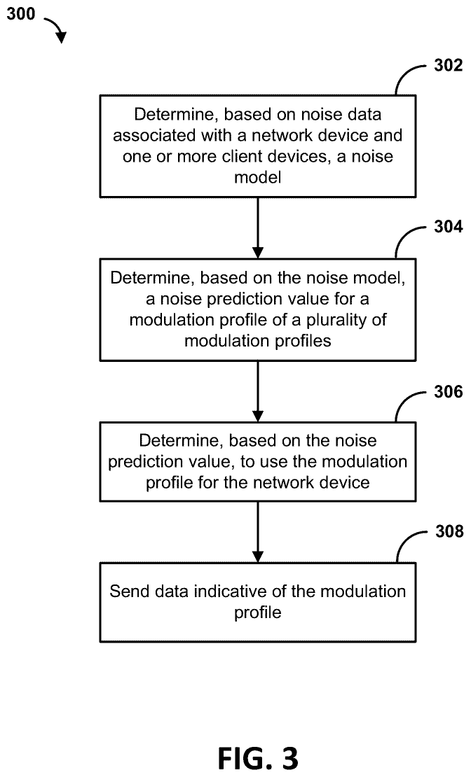

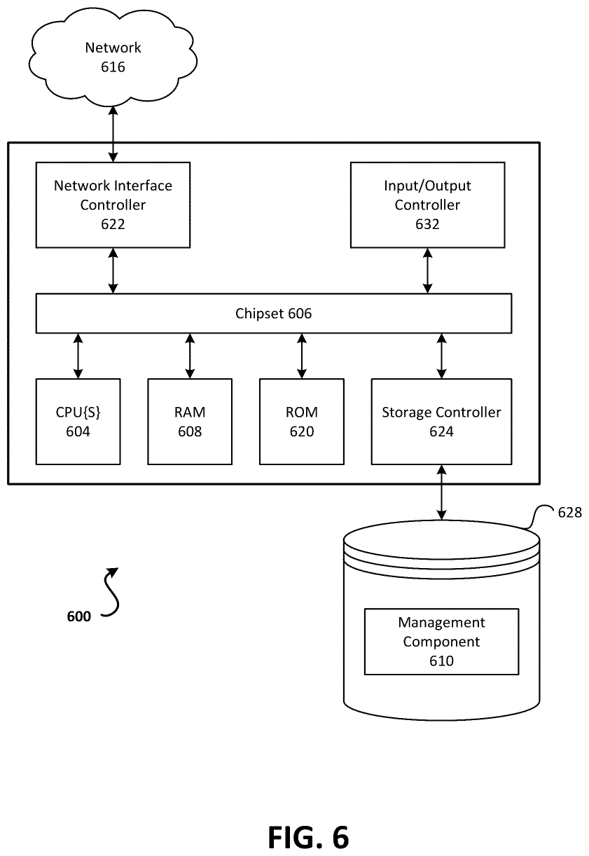

FIG. 3 shows an example method. The method 300 may comprise a computer implemented method for providing a service (e.g., a network service, a communication service). A system and/or computing environment, such as the system 100 of FIG. 1 and/or the computing environment of FIG. 6, may be configured to perform the method 300. The method 300 may be performed in connection with the system illustrated in FIG. 1. Any step or combination of steps of the method 300 may be performed by a computing device, network device, network node, and/or client device, such as any of the devices shown in FIG. 1. Any of the features of the methods of FIGS. 2A and 4-5 may be combined with any of the features and/or steps of the method 300 of FIG. 3.

At step 302, a noise model may be determined. The noise model may be determined based on noise data associated with a network device and one or more client devices. The noise data may be associated with a communication channel (e.g., of a network, of the network device, used by the network device). The network device may comprise one or more of a termination system or a cable modem termination system. The one or more client devices may comprise devices access a network via the network device. The network device may be located at a service entity premises location. The one or more client devices may be located at one or more corresponding customer premises location. The noise data may be determined based on one or more of capturing the noise data or receiving the noise data from an additional device. The noise data may comprise measurements of upstream noise transmitted from the one or more client devices to the network device. The upstream noise may comprise noise from a plurality of different branches of the network, where each branch connects different client devices to the network. The noise from the plurality of different branches may be sent upstream to a device managing communication with the plurality of client devices, such as the network device. The upstream noise may be introduced at locations (e.g., premises) of the one or more client devices, by network infrastructure in between the network device (e.g., and transmitted upstream away from the client devices and to the network device). The noise model may comprise one or more distributions of noise characteristics. At least one of the one or more distributions of noise characteristics may be modified over time based on a decay rate. The noise model may comprise one or more of noise amplitude distribution data, noise duration distribution data, or noise interval distribution data. The noise amplitude distribution data may comprise noise amplitude histogram data indicating a distribution of noise amplitude values. The noise duration distribution data may comprise noise duration histogram data indicating a distribution of noise duration values. The noise interval distribution data may comprise noise interval histogram data indicating a distribution of intervals between noise values.

At step 304, an expected noise metric (e.g., or multiple noise metrics) may be determined. The expected noise metric may comprise one or more of an amount of noise and/or a level of noise. The expected noise metric may comprise one or more of a predicted amount of noise, a level of noise, modulation error rate, a signal-to-noise ratio, a forward error correction metric, a corrected percentage, a failed percentage. The expected noise metric may comprise a predicted modulation error rate, one or more predicted forward error correction (FEC) metrics, or a combination thereof. The expected noise metric (e.g., predicted forward error correction metrics) may comprise a corrected FEC (e.g., percentage corrected). The expected noise metric (e.g., predicted forward error correction metrics) may comprise an uncorrected FEC (e.g., percentage failed to correct). The expected noise metric may be associated with (e.g., specific to) a communication channel of a network. The communication channel may comprise a frequency channel defined by a range of frequencies (e.g., or other logical channel). An expected noise metric may be determined for each communication channel of a plurality of communication channels.

The expected noise metric may be associated with (e.g., specifically predicted for) a modulation profile of a plurality of modulation profiles. The expected noise metric may be determined based on the noise model. The expected noise metric may be determined based on applying (e.g., inputting, selecting for) the modulation profile to the noise model. The noise model modulation profile may be determined based on applying one or more parameters in the modulation profile to the noise model to predict the expected noise metric for the modulation profile (e.g., and for a specific communication channel if multiple channels are used). The modulation profile may comprise one or one parameters for encoding, modulating, transmitting data, or a combination thereof. The modulation profile may comprise one or more of a modulation order, a robustness value, a throughput value, a speed, a parity length, or a number of correctable bits. Determining the expected noise metrics may be based on a calibration associated with a non-noise contribution. The calibration may be based on solving for coefficients for a system of equations for one or more error metrics. The calibration may be based on a plurality of predicted error values in a range limited based on error values determined based on the noise data. The plurality of predicted error values may comprise one or more of a modulation error rate, a signal-to-noise ratio, or a forward error correction metric.

At step 306, the modulation profile may be selected for the network device. The modulation profile may be selected for the communication channel (e.g., while other modulation profiles may be selected for other communication channels). The selection of the modulation profile for the network device may be based on the expected noise metric. The selection of the modulation profile may comprise determining that the modulation profile satisfies one or more conditions associated with network performance. The one or more conditions may comprise one or more of a throughput condition or an error rate condition. The one or more conditions may comprise a combination of the highest throughput and the lowest error rate. The one or more conditions may comprise a combination of a throughput being above a threshold and an error rate being below a threshold.

At step 308, data indicative of the modulation profile may be sent. Sending data indicative of the modulation profile may comprise one or more of sending an identifier of the modulation profile, sending a command to use the modulation profile for a channel, sending a message to the network device, or sending a message to the one or more client devices.

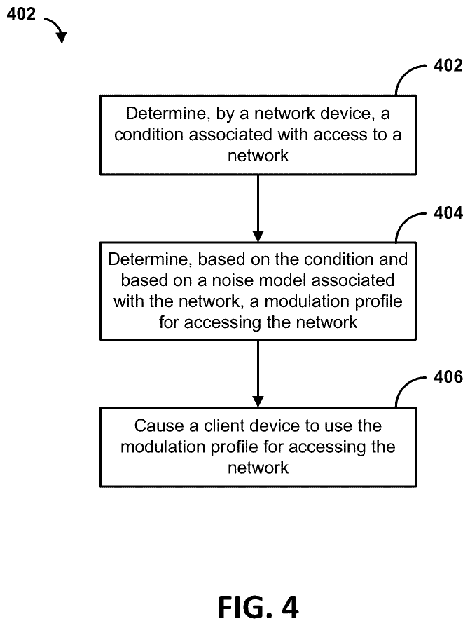

FIG. 4 shows an example method. The method 400 may comprise a computer implemented method for providing a service (e.g., a network service, a communication service). A system and/or computing environment, such as the system 100 of FIG. 1 and/or the computing environment of FIG. 6, may be configured to perform the method 400. The method 400 may be performed in connection with the system illustrated in FIG. 1. Any step or combination of steps of the method 400 may be performed by a computing device, network device, network node, and/or client device, such as any of the devices shown in FIG. 1. Any of the features of the methods of FIGS. 2A, 3 and FIG. 5 may be combined with any of the features and/or steps of the method 400 of FIG. 4.

At step 402, a condition associated with access to a network may be determined. The condition associated with access to the network may be determined by a network device. The network device may comprise one or more of a termination system or a cable modem termination system. One or more client devices may be accessing the network. The one or more client devices may comprise devices accessing the network via the network device. The condition may be associated with the one or more client devices. The network device may be located at a service entity premises location. The one or more client devices may be located at one or more corresponding customer premises location. Determining the condition may comprise determining noise data based on one or more of capturing the noise data or receiving the noise data from an additional device. The noise data may comprise measurements of upstream noise transmitted from the one or more client devices to the network device. Determining the condition may comprise detecting an error rate rising above a threshold, detecting a request for the client device to access a network, or detecting network throughput falling below a threshold.

At step 404, a modulation profile for accessing the network may be selected (e.g., determined). The modulation profile may be selected for accessing a specific communication channel of the network (e.g., while using other modulation profiles for other communication channels. The modulation profile may be selected based on the condition. The modulation profile may be selected based on a noise model associated with the network. The modulation profile may comprise one or one parameters for encoding, modulating, transmitting data, or a combination thereof. The modulation profile may comprise one or more of a modulation order, a robustness value, a throughput value, a speed, a parity length, or a number of correctable bits. The noise model be used by applying the one or more parameters of the modulation profile to the noise model. The noise model may be specific to the communication channel and/or have an input for specifying the communication channel. A plurality of modulation profiles may be applied to the noise model. The modulation profile yielding the best expected noise metric(s) may be selected.

The noise model may comprise one or more distributions of noise characteristics. At least one of the one or more distributions of noise characteristics may be modified over time based on a decay rate. The noise model may comprise one or more of noise amplitude distribution data, noise duration distribution data, or noise interval distribution data. The noise amplitude distribution data may comprise noise amplitude histogram data indicating a distribution of noise amplitude values. The noise duration distribution data may comprise noise duration histogram data indicating a distribution of noise duration values. The noise interval distribution data may comprise noise interval histogram data indicating a distribution of intervals between noise values. Selecting the modulation profile may be based on a calibration associated with a non-noise contribution. The calibration may be based on solving for coefficients for a system of equations for one or more error metrics. The calibration may be based on a plurality of predicted error metrics in a range limited based on error values determined based on the noise data. The plurality of predicted error metrics may comprise one or more of a modulation error rate, a signal-to-noise ratio, or a forward error correction metric.

At step 406, a client device may be caused to use the modulation profile for accessing the network. The client device may be caused to use the modulation profile for accessing the communication channel of the network (e.g., while the client device uses different modulation profiles for different communication channels of the network). Causing the client device to use the modulation profile may comprise one or more of sending an identifier of the modulation profile, sending a command to use the modulation profile for the communication channel, sending a command to the network device to use the modulation profile, or sending a command to the client device to use the modulation profile.

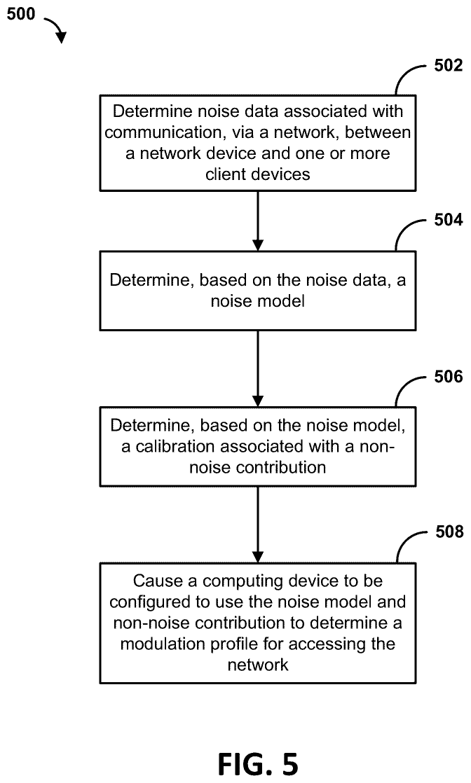

FIG. 5 shows an example method. The method 500 may comprise a computer implemented method for providing a service (e.g., a network service, a communication service). A system and/or computing environment, such as the system 100 of FIG. 1 and/or the computing environment of FIG. 6, may be configured to perform the method 500. The method 500 may be performed in connection with the system illustrated in FIG. 1. Any step or combination of steps of the method 500 may be performed by a computing device, network device, network node, and/or client device, such as any of the devices shown in FIG. 1. Any of the features and/or steps of the methods of FIGS. 2A, 3, and 4 may be combined with any of the features of the method 500 of FIG. 5.

At step 502, noise data associated with communication between a network device and one or more client devices may be determined. The noise data may be associated with communication via a communication channel (e.g., only one specific communication channel, or multiple communication channels) of the network. The communication channel may comprise a frequency channel defined by a range of frequencies (e.g., or other logical channel). The network device may comprise one or more of a termination system or a cable modem termination system. The one or more client devices may comprise devices accessing a network via the network device. The network device may be located at a service entity premises location. The one or more client devices may be located at one or more corresponding customer premises location. Determining the noise data may comprise determining the noise data based on one or more of capturing the noise data or receiving the noise data from an additional device. The noise data may comprise measurements of upstream noise transmitted from the one or more client devices to the network device.

At step 504, a noise model may be determined. The noise model may be determined based on the noise data. The noise model may comprise one or more distributions of noise characteristics. At least one of the one or more distributions of noise characteristics may be modified over time based on a decay rate. The noise model may comprise one or more of noise amplitude distribution data, noise duration distribution data, or noise interval distribution data. The noise amplitude distribution data may comprise noise amplitude histogram data indicating a distribution of noise amplitude values. The noise duration distribution data may comprise noise duration histogram data indicating a distribution of noise duration values. The noise interval distribution data may comprise noise interval histogram data indicating a distribution of intervals between noise values.

At step 506, a calibration associated with a non-noise contribution may be determined. The non-noise contribution may be based on one or more of a difference in receiver power per modem, ingress cancellation, insufficient adaptive equalization, volatile adaptive equalization, or an optical path impairment. The calibration associated with the non-noise contribution may be determined based on the noise model. Determining the calibration may comprise solving for coefficients for a system of equations for one or more error metrics. Determining the calibration may comprise determining a plurality of predicted error values in a range limited based on error values determined based on the noise data. The plurality of predicted error values may comprise one or more of a modulation error rate, a signal-to-noise ratio, or a forward error correction metric.

At step 508, a computing device may be caused to be configured to use the noise model and non-noise contribution to determine a modulation profile for accessing the network (e.g., for accessing a communication channel of the network). Causing a computing device to be configured to use the noise model and non-noise contribution to determine the modulation profile for accessing the network (e.g., for accessing a communication channel of the network) may comprise sending a message to the computing device indicating the noise model is one or more of updated or available. The modulation profile may comprise one or one parameters for encoding, modulating, transmitting data, or a combination thereof. The modulation profile may comprise one or more of a modulation order, a robustness value, a throughput value, a speed, a parity length, or a number of correctable bits. The computing device may comprise a cable modem termination system, a network node, a router, an access point, and/or the like. A modulation profile may be determined by the computing device for each communication channel of a plurality of communication channels. Different modulation profiles may be used for different communication channels of the network.

FIG. 6 depicts a computing device that may be used in various aspects, such as the servers, nodes, and/or devices depicted in FIG. 1. With regard to the example architecture of FIG. 1, the server device 102, the network device 104, the computing device 108, the network node 110, and the one or more client devices 106 may each be implemented in an instance of a computing device 600 of FIG. 6. The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 2A, FIG. 3, FIG. 4, and FIG. 5.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random access memory (RAM) 608 used as the main memory in the computing device 600. The chipset 606 may further provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described in relation to FIG. 2A, FIG. 3, FIG. 4, and FIG. 5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

The term “or” when used with “one or more of” is used in its inclusive sense (and not in its exclusive sense) so that when used, for example, to connect a list of elements, the term “or” means one, some or all of the elements in the list. The term “or” when used with “at least one of” is used in its inclusive sense (and not in its exclusive sense) so that when used, for example, to connect a list of elements, the term “or” means one, some or all of the elements in the list. For example, the phrases “one or more of A, B, or C” includes any of the following: A, B, C, A and B, A and C, B and C, and A and B and C. Similarly the phrase “one or more of A, B, and C” includes any of the following: A, B, C, A and B, A and C, B and C, and A and B and C. The phrase “at least one of A, B, or C” includes any of following: A, B, C, A and B, A and C. B and C, and A and B and C. Similarly, the phrase “at least one of A, B, and C” includes any of following: A, B, C, A and B, A and C, B and C, and A and B and C.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
determining, based on noise data associated with a communication channel of a network device and one or more client devices, a noise model;
determining, based on the noise model, and based on applying a modulation profile of a plurality of modulation profiles, an expected noise metric associated with the communication channel;
selecting, based on the expected noise metric, the modulation profile for the network device; and
sending data indicative of the modulation profile.

2. The method of claim 1, wherein the expected noise metric comprises one or more of an amount of noise or a level of noise.

3. The method of claim 1, wherein the noise data comprises measurements of upstream noise transmitted from the one or more client devices to the network device.

4. The method of claim 1, wherein the noise model comprises one or more of noise amplitude distribution data, noise duration distribution data, or noise interval distribution data.

5. The method of claim 1, wherein determining the expected noise metric is based on a calibration associated with a non-noise contribution.

6. The method of claim 1, wherein selecting the modulation profile comprises determining that the modulation profile satisfies one or more conditions associated with network performance.

7. The method of claim 1, wherein sending data indicative of the modulation profile comprises one or more of sending an identifier of the modulation profile, sending a command to use the modulation profile for a channel, sending a message to the network device, or sending a message to the one or more client devices.

8. A method comprising:
determining, by a network device, a condition associated with access to a network;
selecting, based on the condition and based on a noise model associated with the network, a modulation profile for accessing a communication channel of the network; and
causing a client device to use the modulation profile for accessing the communication channel of the network.

9. The method of claim 8, wherein the network device comprises one or more of a termination system or a cable modem termination system.

10. The method of claim 8, wherein determining the condition comprises detecting an error rate rising above a threshold, detecting a request for the client device to access a network, or detecting network throughput falling below a threshold.

11. The method of claim 8, wherein the noise model comprises one or more of noise amplitude distribution data, noise duration distribution data, or noise interval distribution data.

12. The method of claim 8, wherein selecting the modulation profile is based on a calibration associated with a non-noise contribution.

13. The method of claim 8, wherein causing the client device to use the modulation profile comprises one or more of sending an identifier of the modulation profile, sending a command to use the modulation profile for the communication channel, sending a command to the network device to use the modulation profile, or sending a command to the client device to use the modulation profile.

14. A method comprising:
determining noise data associated with communication, via a communication channel of a network, between a network device and one or more client devices;
determining, based on the noise data, a noise model;
determining, based on the noise model, a calibration associated with a non-noise contribution; and
causing a computing device to be configured to use the noise model and non-noise contribution to determine a modulation profile for accessing the communication channel of the network.

15. The method of claim 14, wherein the non-noise contribution is based on one or more of a difference in receiver power per modem, ingress cancellation, insufficient adaptive equalization, volatile adaptive equalization, or an optical path impairment.

16. The method of claim 14, wherein the noise data comprises measurements of upstream noise transmitted from the one or more client devices to the network device.

17. The method of claim 14, wherein the noise model comprises one or more of noise amplitude distribution data, noise duration distribution data, or noise interval distribution data.

18. The method of claim 14, wherein determining the calibration comprises solving for coefficients for a system of equations for one or more error metrics.

19. The method of claim 14, wherein determining the calibration comprises determining a plurality of predicted error values in a range limited based on error values determined based on the noise data.

20. The method of claim 14, wherein causing a computing device to be configured to use the noise model and non-noise contribution to determine the modulation profile for accessing the communication channel of the network comprises sending a message to the computing device indicating the noise model is one or more of updated or available.
